(19) United States
(12) Patent Application Publication
(10) Pub. No.: US 2005/0029781 A1
(43) Pub. Date: Feb. 10, 2005

(54) Dual cushion passenger airbag

(76) Inventors: Mark L. Enders, Pleasarnt View, UT (US); Richard J. Welford, Layton, UT (US); Larry D. Rose, South Weber, UT (US); Patrick D. Jamison, North Ogden, UT (US); Trudy C. Lewis, West Haven, UT (US); Guy W. Nalder, Roy, UT (US); Bradley W. Smith, Ogden, UT (US); Timothy M. Martersteck, Ogden, UT (US); Randy K. Jones, Brigham City, UT (US)

Correspondence Address: Sally J. Brown;AUTOLIV ASP, INC., 3350 Airport Road, Ogden, UT, 84405, US

(21) Appl. No.: 10/637,239

(22) Filed: Aug. 8, 2003

(51) Int. Cl. B60R 21/16

(52) U.S. Cl. 280/732

(57) ABSTRACT

A passenger airbag assembly having a first cushion and a second cushion is disclosed. An inflator mechanism that independently inflates the first cushion and the second cushion may also be added. The inflator mechanism may either be a dual stage inflator or two separate inflators. Preferably, the airbag assembly is designed such that the inflator mechanism begins the inflation of the first cushion prior to beginning the inflation of the second cushion. A housing may also be added to the airbag assembly. The housing encloses the inflator mechanism and is attached to the first cushion and the second cushion. The airbag assembly may be designed such that when the first cushion and the second cushion are inflated, the second cushion is positioned between the first cushion and the vehicle's windshield. Furthermore, the airbag assembly may also be made such that when the first cushion is inflated, the first cushion will push a vehicle occupant towards the vehicle's passenger seat.

### BACKGROUND OF THE INVENTION

1. Field of the Invention

The present invention relates to passenger airbags. More specifically, the present invention relates to a novel dual cushion passenger airbag system that may be installed within a dashboard of a vehicle.

2. Description of Related Art

Inflatable safety restraints or airbags enjoy widespread acceptance as passive passenger restraints for use in motor vehicles. Airbags have built a reputation of preventing numerous deaths and injuries over the years of development, testing, and use. Studies show that in some instances, the use of frontally placed vehicular airbags can reduce the number of fatalities in head-on collisions by 25% among drivers using seat belts and by more than 30% among unbelted drivers. Other statistics suggest that in a frontal collision, the combination of a seat belt and an airbag can reduce the incidence of serious chest injuries by 65% and the incidence of serious head injuries by up to 75%. These numbers and the thousands of prevented injuries they represent demonstrate the life saving potential of airbags and the need to encourage their use, production, and development.

In part as a result of the benefits such as those described above, automakers are now required to install airbags in most new vehicles manufactured for sale in the United States. Many automobile manufacturers have turned this airbag technology requirement into a marketing tool. Enticed by the promise of added safety, vehicle purchasers frequently seek out vehicles with sophisticated airbag systems.

Airbags are generally linked to a control system within the vehicle that triggers their initiation when a collision occurs. This control system is often referred to as an electronic control unit (herein referred to as an “ECU”). The ECU includes a sensor that continuously monitors the acceleration and deceleration of the vehicle. This information is sent to a processor which processes it using an algorithm to determine if a deceleration experienced by the vehicle is a collision or not. If this accelerometer measures an abnormal deceleration, such as one caused by a collision event, it triggers the ignition of an airbag inflator.

When the processor of the ECU determines, based on a set of pre-determined criteria, that the vehicle is experiencing a collision, the ECU transmits an electrical current to an initiator assembly. The initiator assembly is in turn connected to an inflator that is coupled to the airbag module. The initiator activates the inflator. An inflator is a gas generator that typically uses a compressed or liquefied gas or mixture of gases, a solid fuel, or some combination of the two, to rapidly generate a large volume of inflation gas. This inflation gas is then channeled into the airbag. The gas inflates the airbag, allowing it to absorb the impact of the vehicle occupants and thus protecting them from impact against the steering column, the windshield, the instrument panel, and/or other portions of the vehicle interior.

Airbags may be positioned in a variety of locations throughout the vehicle. Airbags located within the steering wheel aid in preventing the driver from striking the steering wheel and the windshield in the event of an accident. Airbags have also been placed in the dashboard directly in front of the passenger seat in a vehicle. More recently, inflatable curtain airbags have been installed on the side portions of the vehicle in order to prevent the occupants from striking the doors and windows in the vehicle when an accident throws the occupant in that direction. Airbags have also been placed in seat belts, creating what has been termed inflatable seat belts. Knee bags and pelvic airbags have also been created to prevent an occupant's lower body from striking the vehicle.

One type of airbag that has received recent attention is a“passenger airbag.” Passenger airbags are those airbags that are designed to protect a vehicle occupant seated on the passenger side of the vehicle. Such passenger airbags are generally positioned within the dashboard and designed to inflate in front of the passenger to prevent the passenger from harmfully impacting the dashboard, the windshield, or other frontal portions of the vehicle during a crash.

As experience with the manufacturer and use of passenger airbags has progressed, the engineering challenges in their design, construction, and use have become better understood. For example, passenger airbags are currently designed to be large and bulky such that the inflated airbag fills the entire space between the windshield and the occupant. Such size is necessary so that when the occupant impacts the airbag during the crash, the loads associated with the occupant's forward movement will be reacted into the windshield and/or the instrument panel.

Inflation of such a large and bulky airbag requires that a substantial volume of inflation gas (typically between about 100 to about 160 liters) be channeled into the airbag during a crash. In order to add such a large volume of inflation gas within the time frame required by most accidents (typically between about 60 to about 80 milliseconds), the velocity of the inflation gas entering the airbag must be very high.

Unfortunately, the use of such an airbag system that requires the inflation gas to be injected into the airbag at such a high velocity creates serious disadvantages for vehicle manufacturers. Specifically, the high velocity of the inflation gas can cause the airbag to impact a vehicle occupant that is not properly seated or otherwise “out of position”(herein referred to as“OOP”).

The problems associated with an airbag forcibly impacting a vehicle occupant are exacerbated by the fact that most airbag systems are designed to restrain a vehicle occupant that is properly positioned and seated on the passenger seat. For occupants that are OOP, the risk that the occupant will be injured in the crash increases. For example, an OOP occupant is most likely not wearing a seat belt, whereas, the expected occupant position generally anticipates that the occupant is wearing a seatbelt. Without a seatbelt, the inertia of the OOP occupant keeps them moving forward towards the instrument panel and windshield and amplifies the force of the impact of the OOP occupant with the airbag. Similarly, if the OOP occupant is resting his or her head on the dashboard, there is a greater likelihood that the deploying airbag will injure the occupant.

Because of the problems associated with OOP occupants, many recent airbag systems have included a dual stage inflator and/or complex sensor system that is attached to the ECU. These sensor systems are designed such that during a crash, the sensor system determines and detects whether the vehicle occupant is properly positioned or OOP. If the vehicle occupant is positioned properly, the sensor system and/or the ECU will cause the airbag to undergo a normal deployment. However, if the sensor system determines that the occupant is OOP, the sensor system and/or the ECU will suppress the deployment of the airbag and/or deploy the airbag in a manner that is gentler, softer, and more accommodating to the OOP occupant.

Unfortunately, the use of these sensor systems creates serious disadvantages for vehicle and/or airbag manufacturers. Specifically, many of these sensor systems are very expensive and difficult to produce and install onto a vehicle. Additionally, most sensor systems are complex and sophisticated, and as a result, it is often very difficult to adapt the sensor system to a wide-variety of vehicle models and/or crash scenarios.

Accordingly, there is a need in the art for a novel passenger airbag assembly that addresses and/or solves one or more of the above-listed problems. Such a device is disclosed herein.

### SUMMARY OF THE INVENTION

The apparatus of the present invention has been developed in response to the present state of the art, and in particular, in response to the problems and needs in the art that have not yet been fully solved by currently available passenger airbag assemblies. Thus, the present invention provides a passenger airbag assembly that may be mounted onto a dashboard of a vehicle.

The airbag assembly includes a first cushion, a second cushion, and an inflator mechanism that may independently inflate and deploy the first cushion and the second cushion. Preferably, the inflator mechanism is constructed such that it will begin to inflate the first cushion prior to beginning the inflation of the second cushion. An ECU that detects a crash and/or provides an initiation signal to the inflator mechanism may also be added.

In some embodiments, the inflator mechanism may be a dual stage inflator. The dual stage inflator comprises a first gas generating chamber and a second gas generating chamber. Preferably, the first gas generating chamber produces a volume of first inflation gas that is used to inflate the first cushion. Similarly, the second gas generating chamber produces a second volume of inflation gas that may be used to inflate the second cushion.

Other embodiments of the present invention may also be made in which the inflator mechanism comprise two separate and distinct inflators: a first inflator and a second inflator. Preferably, the first inflator produces the quantity of first inflation gas that is used to inflate the first chamber whereas the second inflator produces the quantity of second inflation gas that is used to inflate the second cushion.

The airbag assembly may further comprise a housing that is attached to the first cushion and the second cushion. The housing is designed to enclose the inflator mechanism. The housing may further comprise a divider plate that functions to separate the housing into a first chamber and a second chamber. A V-shaped section may also be added to the top of the divider plate.

Preferably, the first cushion comprises a first throat portion and the second cushion comprises a second throat portion. The first chamber is preferably attached to the first throat portion whereas the second throat portion is attached to the second chamber. Such attachment may be accomplished through the use of one or more clamp rings that operate to cinch the throat portions to the chambers. Of course, those of skill in the art will recognize that other types of fasteners and/or other methods of attaching the throat portions to the chambers may also be used.

In the event of a crash or accident, the inflator mechanism will produce and/or channel a volume of first inflation gas into the first cushion. Such and influx of gas will inflate and deploy the first cushion in a substantially vertical direction. As used herein, a “substantially vertical direction” means that the first cushion deploys all or mostly in an upwards direction such that all or a portion of the cushion becomes positioned along or proximate to the vehicle's windshield. Preferably, the initial pressure of the first inflation gas within the first cushion is less than about 2 pounds per square inch, thereby ensuring that the inflating first cushion will not injure an OOP occupant.

The airbag assembly may further be configured such that a portion or section of the first cushion may also be attached to the second cushion. In some embodiments, such attachment may be preferably in that as the first cushion inflates, the first cushion will pull and/or exert tension upon the uninflated second cushion such that all or a portion of the uninflated second cushion becomes positioned between the first cushion and the windshield.

Preferably, the airbag assembly is further constructed such that if the inflated first cushion contacts and/or impacts an OOP occupant, the first cushion will gently push the OOP occupant towards the passenger seat. More specifically, if the inflated first cushion impacts the OOP occupant, the first cushion will begin to gently push the OOP occupant towards the passenger seat such that the OOP occupant begins to move away from the dashboard prior to the deployment of the second cushion.

The airbag assembly of the present invention may be further constructed such that if the inflated first cushion contacts and/or impacts an OOP occupant, the first cushion will gently push the OOP occupant towards the passenger seat. More specifically, if the inflated first cushion impacts the OOP occupant, the first cushion will begin to gently push the OOP occupant towards the passenger seat such that the OOP occupant begins to move away from the dashboard prior to the deployment of the second cushion. As a result, the present invention may be used to protect an OOP occupant without the use of the expensive and complex sensor systems that are required by many prior art airbag systems.

Once the first cushion begun inflating, the second cushion may also be inflated by the inflator mechanism. Specifically, the inflator mechanism will produce and/or channel a volume of second gas into the second cushion. In turn, this influx of the second gas causes the cushion to inflate and deploy upwardly towards the vehicle's windshield.

The airbag assembly is constructed such that when the second cushion is inflated, the second cushion becomes positioned behind the first cushion. More specifically, the second cushion is constructed such that when it is inflated, the second cushion becomes positioned between the windshield and the first cushion.

The airbag assembly is further configured such that deployment of the second cushion behind the first cushion pushes and/or moves the first cushion towards the vehicle passenger seat. Such movement of the first cushion ensures that the first cushion becomes situated in a position that is capable of protecting and restraining the movement of the vehicle occupant during a crash.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partially cutaway perspective view of a vehicle interior including a passenger airbag assembly according to the present invention;

FIG. 2 is a cross-sectional view of the airbag assembly of the passenger airbag assembly taken along the line A-A of FIG. 1;

FIG. 3 is a partially cutaway side view of the vehicle interior including the passenger airbag assembly of FIG. 1 in which the first cushion is being inflated and deployed;

FIG. 4 is a partially cutaway side view of the vehicle interior including the passenger airbag assembly of FIG. 1 in which the first cushion is being inflated and deployed;

FIG. 5 is a partially cutaway side view of the vehicle interior including the passenger airbag assembly of FIG. 1 in which the second cushion is being inflated and deployed;

FIG. 6 is a partially cutaway side view of the vehicle interior including the passenger airbag assembly of FIG. 1 in which both the first cushion and the second cushion have been fully inflated and deployed;

FIG. 7 is a partially cutaway perspective view of the vehicle interior including the passenger airbag assembly of FIG. 1 in which both the first cushion and the second cushion have been fully inflated and deployed;

FIG. 8 is a partially cutaway perspective view of a vehicle interior including a further embodiment of the passenger airbag assembly of the present invention;

FIG. 9 is a cross-sectional view of the airbag assembly of the passenger airbag assembly taken along the line B-B of FIG. 8;

FIG. 10 is a cross-sectional view of the airbag assembly of the passenger airbag assembly taken along the line C-C of FIG. 8;

FIG. 11 is a partially cutaway perspective view of a vehicle interior including a further embodiment of the passenger airbag assembly of the present invention;

FIG. 12 is a cross-sectional view of the airbag assembly of the passenger airbag assembly taken along the line D-D of FIG. 11;

FIG. 13 is a partially cutaway perspective view of a vehicle interior including a further embodiment of the passenger airbag assembly of the present invention; and

FIG. 14 is a cross-sectional view of the airbag assembly of the passenger airbag assembly taken along the line E-E of FIG. 13.

### DETAILED DESCRIPTION OF THE PREFERRED EMBODIMENTS

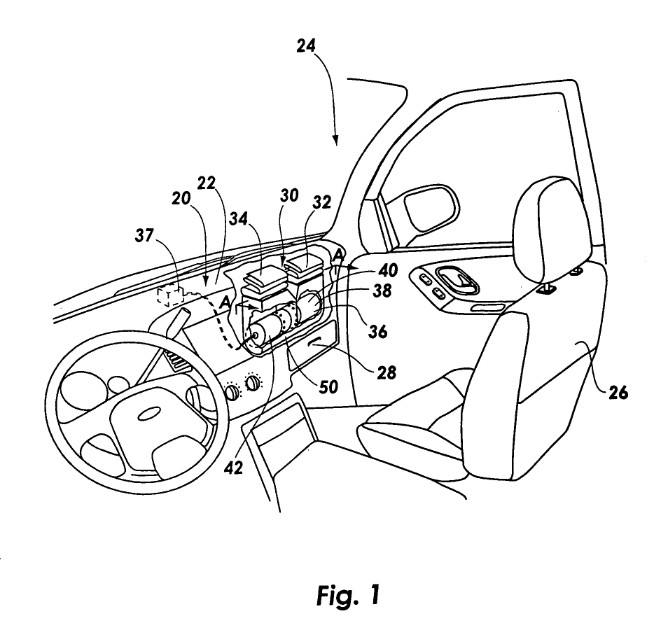

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 14, is not intended to limit the scope of the invention, as claimed, but is merely representative of presently preferred embodiments of the invention.

Referring first to FIG. 1, a partial cutaway perspective view of the front-passenger side of a vehicle interior 20 is illustrated. The vehicle interior 20 includes a dashboard 22 and a windshield 24 that are positioned in front of a passenger seat 26. A glove box 28 that is capable of storage is also illustrated below the dashboard 22.

The vehicle interior 20 also includes a passenger airbag assembly 30 that is positioned within the dashboard 22. The airbag assembly 30 includes two cushions: a first cushion 32 and a second cushion 34. The cushions 32, 34 have a stored configuration and an inflated configuration. As seen in FIG. 1, the cushions 32, 34 are illustrated in their stowed configuration.

The airbag assembly 30 further comprises an inflator mechanism 36 that is in fluid communication with the cushions 32, 34. The inflator mechanism 36 is a pyrotechnic or other device that independently inflates and deploys the first cushion 32 and the second cushion 34 during an accident or crash. Preferably, the inflator mechanism 36 is constructed to begin the deployment of the first cushion 32 prior to beginning the deployment of the second cushion 34. An ECU 37 (represented graphically as a box) that detects a crash and/or provides a signal to the inflator mechanism 36 that initiates the inflation of the cushions 32, 34 has also been illustrated.

The inflator mechanism 36 may be a dual stage inflator 38. As used herein, a “dual stage inflator” is a pyrotechnic or gas generating device that is capable of producing two separate quantities of inflation gas. Of course, multiple and/or other types of inflators may also be used as the inflator mechanism 36.

In the embodiment shown in FIG. 1, the dual stage inflator 38 comprises a first gas generating chamber 40 that produces a first quantity of inflation gas and a second gas generating chamber 42 that produces a second quantity of inflation gas. Preferably, the dual stage inflator 38 is configured such that the first gas generating chamber 40 operates to inflate the first cushion 32 whereas the second gas generating chamber 42 operates to inflate and deploy the second cushion 34.

The airbag assembly 30 further includes a housing 50 that is attached to the cushions 32, 34. The housing 50 encloses and houses the inflator mechanism 36. Accordingly, the housing 50 is made of steel, injection-molded plastic, aluminum, or other materials that are capable of withstanding the high pressures associated with actuation of the inflator mechanism 36.

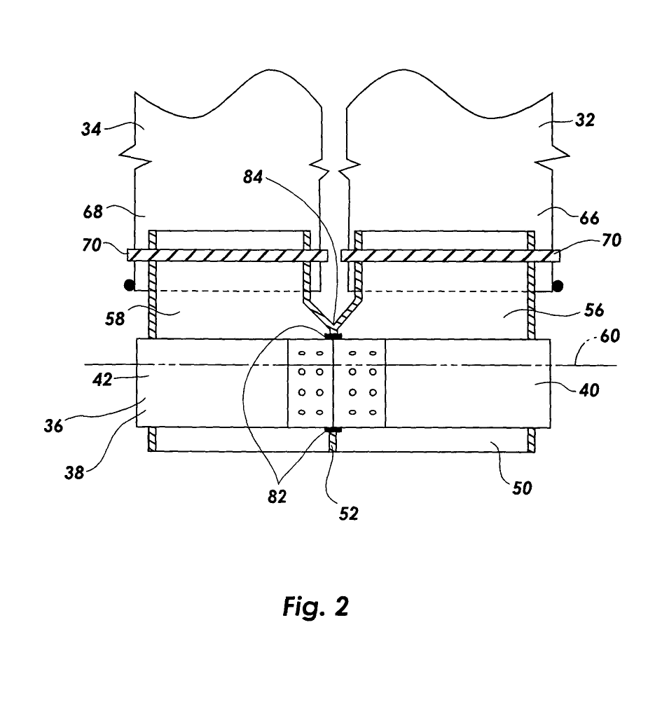

Referring now to FIG. 2, a cross-sectional view taken along the line A-A of FIG. 1 illustrates the housing 50, the inflator mechanism 36, and the airbag assembly 30 in greater detail. The housing 50 may comprise a divider plate 52 that is positioned perpendicular to the longitudinal axis 60 of the inflator 38. The divider plate 52 operates to separate the housing 50 into a first chamber 56 and a second chamber 58.

The divider plate 52 is further constructed such that the inflator 38 may pass through the divider plate 52. Preferably, this is accomplished such that the first gas generating chamber 40 is positioned within the first chamber 56 and the second gas generating chamber 42 is positioned within the second chamber 58.

The first chamber 56 is attached to a first throat portion 66 of the first cushion 32. Similarly, the second chamber 58 is attached to a second throat portion 68 of the second cushion 34. In the embodiment shown in FIG. 2, the chambers 56, 58 are attached to the throat portions 66, 68 via one or more clamp rings 70 that operate to cinch the throat portions 66, 68 over the chambers 56, 58. Of course, those of skill in the art will recognize that other types of fasteners and/or other methods of attaching the throat portions 66, 68 to the housing 50 may also be used. Yet further embodiments may also be constructed in which the throat portions 66, 68 are attached to the housing 50.

A sealing ring 82 may additionally be added to the divider plate 52. The sealing ring 82 is preferably made of rubber and the like and is designed such that when the inflator 38 passes through the divider plate 52, the sealing ring 82 surrounds the inflator 52 and creates an airtight seal between the first chamber 56 and the second chamber 58.

Referring still to FIG. 2, the divider plate 52 may additionally comprise a V-shaped section 84. The V-shaped section 84 is positioned along the top of the divider plate 52 such that it is located between the clamp rings 70. In some embodiments, the addition of the V-shaped section may be preferable in that the V-shaped section 84 ensures that the first throat portion 66 remains separate from the second throat portion 68.

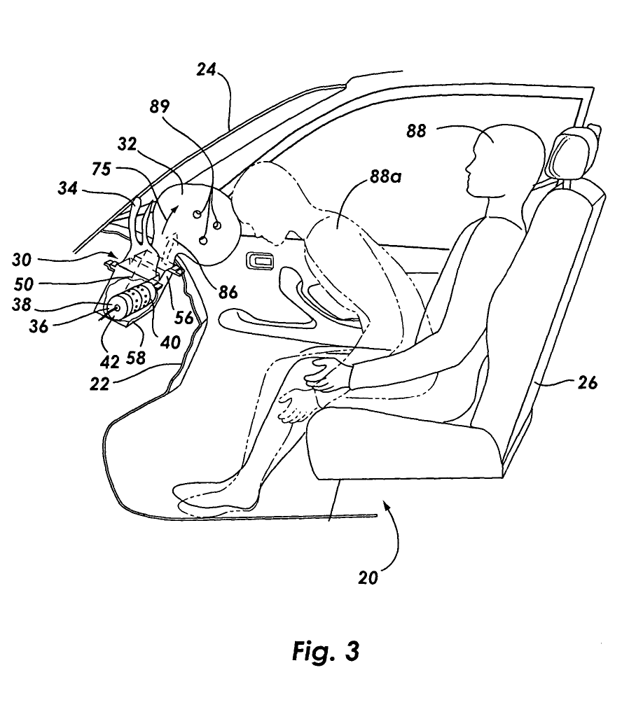

FIG. 3 is a partially cutaway side view that illustrates the vehicle interior 20 and the airbag assembly 30 in greater detail. A vehicle occupant is also illustrated. The vehicle occupant may either be the properly positioned occupant 88 or may be an OOP occupant 88a (shown in phantom lines).

In the event of a crash or accident, the ECU 37 (shown in FIG. 1) detects the crash and signals the inflator mechanism 36 to begin deploying the first cushion 32. More specifically, the ECU 37 signals the inflator mechanism 36 to begin deploying the first cushion 32 by having the first gas generating chamber 40 produce a volume of first inflation gas 86 (represented graphically by an arrow).

After the first inflation gas 86 is produced, the gas 86 is directed out of the first gas generating chamber 40 into the first chamber 56. Because the sealing ring 82 (shown in FIG. 2) seals the first chamber 56, the first gas 86 cannot access or enter the second chamber 58. Rather, the first gas 86 is directed into the first cushion 32 by flowing through the throat portion 66 (shown in FIG. 2). In turn, this influx of the first gas 86 into the first cushion 32 inflates the first cushion 32 and deploys the cushion 32 in a substantially vertical direction (as shown by arrow 75). As used herein, “substantially vertical direction” means that the first cushion 32 deploys all or mostly in an upwards direction such that all or a portion of the cushion 32 becomes positioned along or proximate to the windshield 24.

The first cushion 32 is constructed such that when it is inflated, the first cushion 32 may hold between about 60 to about 75 liters of the first inflation gas 86. Of course, other sizes of the first cushion 32 may also be used. In one of the presently preferred embodiments, the initial pressure of the inflation gas 86 within the first cushion 32 is less than about 2 psi, thereby ensuring that any contact between the first cushion 32 and the OOP occupant 88a will not injure the OOP occupant 88a. Of course, other embodiments may also be made in which the initial pressure of the inflation gas 86 within the first cushion 32 is greater than or equal to 2 psi.

The airbag assembly 30 may be further constructed such that if the inflated first cushion 32 contacts and/or impacts the OOP occupant 88a, the first cushion 32 will gently push the OOP occupant 88a towards the passenger seat 26. More specifically, if the inflated first cushion 32 impacts the OOP occupant 88a, the first cushion 32 will begin to gently push the OOP occupant 88a towards the passenger seat 26 such that the OOP occupant 88a begins to move away from the dashboard 24 prior to the deployment of the second cushion 34.

Referring still to FIG. 3, the airbag assembly 30 may further be designed such that the first inflation gas 86 may be vented out of the first cushion 32 during a crash. In some embodiments, such venting of the first gas 86 may be preferable in that it makes the first cushion 32 softer and less likely to injure the occupant 88, 88a. In the embodiment shown in FIG. 3, the airbag assembly 30 is designed such that during a crash, the first gas 86 may vent out of the first cushion 32 by passing through one or more vent holes 89. Of course, other methods of venting the first gas 86 out of the first cushion 32 may also be used. Still further embodiments may be constructed in which the first gas 86 is not vented out of the cushion 32.

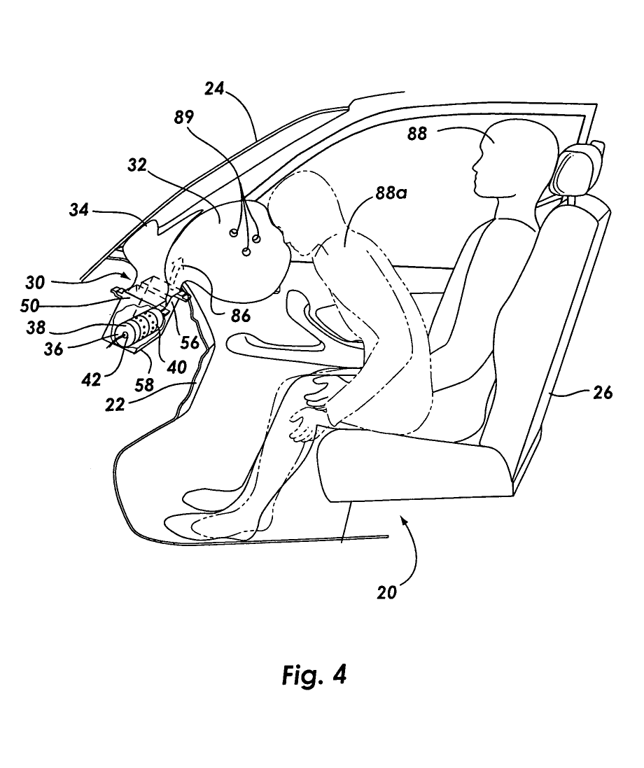

Referring now to FIG. 4, a partially cutaway side view of the vehicle interior 20 and the airbag assembly 30 illustrates the deployment of the airbag assembly in greater detail. As can be seen in FIG. 4, the airbag assembly 30 may be configured such that a portion or section of the first cushion 32 is connected to a portion of the second cushion 34. As a result, as the first cushion 32 is being inflated, the first cushion 32 pulls and/or exerts tension upon the uninflated second cushion 34 such that all or a portion of the uninflated second cushion 34 becomes positioned between the first cushion 32 and the windshield 24.

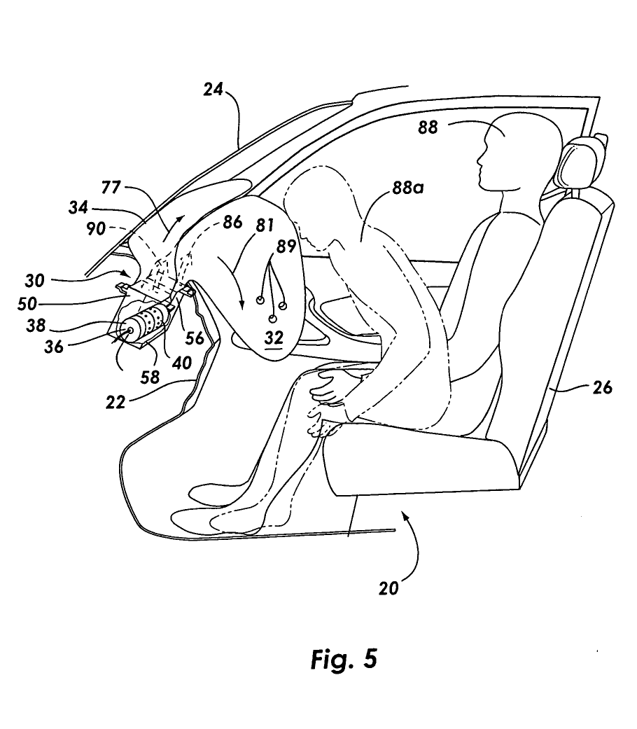

Referring now to FIG. 5, a partially cutaway side view illustrates the inflation and deployment of the second cushion 34 in greater detail. Specifically, once the first cushion 32 has begun inflating, the ECU 37 (shown in FIG. 1) will cause the inflator mechanism 36 to begin inflating the second cushion 34. In some embodiments, the inflation of the second cushion 34 will not begin until after the first cushion 32 has been completely inflated and deployed. Other embodiments may also be constructed in which the second cushion 34 begins to inflate prior to the first cushion 32 being completely inflated and deployed by the first gas 86.

To deploy the second cushion 34, the ECU 37 causes the second gas generating chamber 42 to produce a volume of second inflation gas 90 (represented graphically by an arrow). This second inflation gas 90 is directed out of the second gas generating chamber 42 and enters the second chamber 58. Because the sealing ring 82 (shown in FIG. 2) seals the second chamber 58, the second inflation gas 90 cannot access or enter the first chamber 56. Rather, the second inflation gas 90 is directed into the second cushion 34 by flowing through the throat portion 68 (shown in FIG. 2). In turn, this influx of the second gas 90 into the second cushion 34 causes the cushion 34 to inflate and deploy upwardly towards the windshield 24 (as shown by arrow 77).

The second cushion 34 may further be constructed such that the pressure of the second inflation gas 90 within the second cushion 34 is greater than the pressure of the first gas 86 within the first cushion 32. In some embodiments, the pressure of the second inflation gas 90 within the second cushion 34 may be from about 4 to about 7 psi. However, other embodiments may also be made in which the pressure of the second inflation gas 90 within the second cushion 34 may be as high as about 20 psi.

In the embodiment shown in FIG. 4, the second cushion 34 is constructed such that when the second cushion 34 is inflated, the second cushion 34 becomes positioned behind the first cushion 32. More specifically, the second cushion 34 is constructed such that when it is inflated, the second cushion 34 becomes positioned between the windshield 24 and the first cushion 32. In some embodiments, such positioning of the second cushion 34 may be preferable in that it will push the first cushion 32 away from the windshield 24 (as shown by arrow 81). This movement of the first cushion 32 ensures that the first cushion 32 becomes situated in a position that is capable of restraining the movement of the vehicle occupant 88, 88a during a crash.

Referring still to FIG. 5, the airbag assembly 30 has further been constructed such that the second cushion 34 will not impact the occupant 88a until after the second cushion 34 has moved the first cushion 32 into a position that is capable of restraining the movement of the OOP occupant 88a. Of course, other embodiments may also be made such that the second cushion 34 will not impact either the vehicle occupant 88 or the OOP occupant 88a until after the second cushion 34 has been fully inflated and deployed. Yet further embodiments may also be made in which the airbag assembly 30 is constructed such that the second cushion 34 will impact a portion of the vehicle occupant 88, 88a during deployment. Still further embodiments may be constructed such that after the second cushion 34 has been deployed, the second cushion 34 will receive and/or cushion the head or torso of the vehicle occupant 88, 88a.

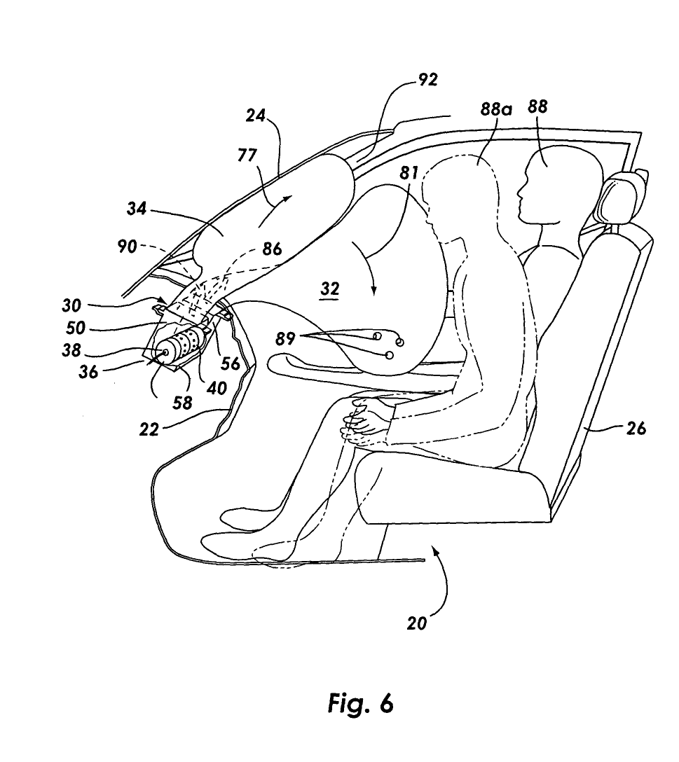

Referring now to FIG. 6, a partially cutaway side view of the vehicle interior 20 shows the airbag assembly 30 after both the first cushion 32 and the second cushion 34 have been fully inflated and deployed. As can be seen in FIG. 6, when the cushions 32, 34 are inflated, the second cushion 34 is positioned behind the first cushion 32 such that the second cushion 34 covers all or a portion of the vehicle's A-pillar 92. Of course, other shapes and/or configurations may also be used. Specifically, additional embodiments may be constructed in which the shape of the second cushion 34 is selected such that the second cushion 34 will follow the contours of the vehicle interior 20 and/or the windshield 24.

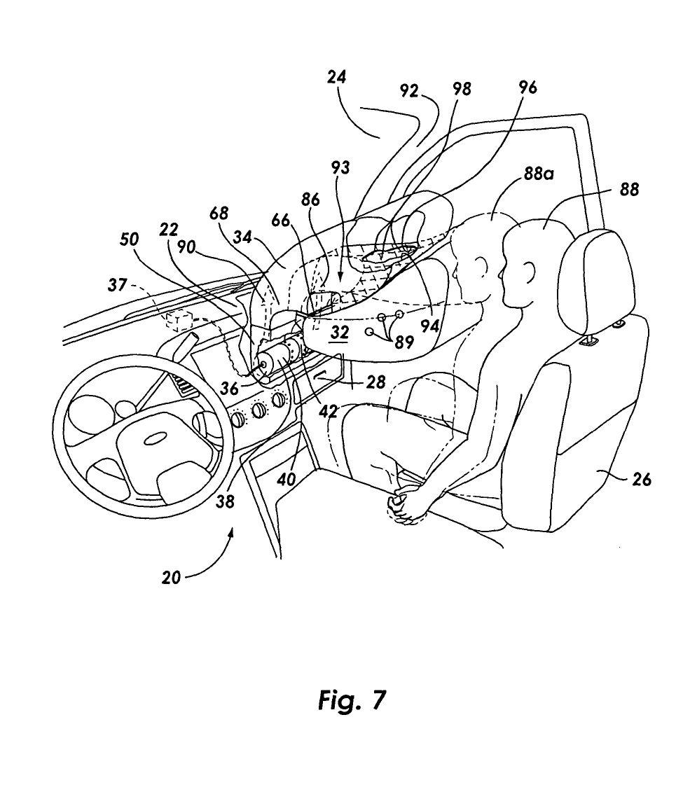

Referring now to FIG. 7, a partially cutaway perspective of the vehicle interior 20 and the airbag assembly 30 in which the cushions 32, 34 have been fully inflated and deployed. As noted above, the first cushion 32 may be attached to the second cushion 34. Preferably, this may be accomplished by connecting a top portion 94 of the first cushion 32 to a top portion 96 of the second cushion 34 by sewing along sew lines 98. Of course, those of skill in the art will recognize that other embodiments may also be made in which top portion 94 is attached to the top portion 96 via fasteners, one or more fabric panels, gluing, welding, adhesive bonding, and the like. Yet further embodiments may be constructed in which the top portion 94 is connected to the top portion 96 such that the top portion 94 is integral with all or a portion of the top portion 96. Yet further embodiments may be made in which the second cushion 34 is separate from the first cushion 32.

The airbag assembly 30 may further be constructed such that the first cushion 32 is shaped to mesh with the second cushion 34. This is preferably accomplished by constructing the first cushion 32 with a jog 93 that accommodates the deployment of the second cushion 34. More specifically, the first cushion 32 is constructed with a jog 93 that is sized and designed such that when the second cushion 34 is deployed, the second cushion 34 will deploy through an opening created by the jog 93.

In the embodiment shown in FIG. 7, the airbag assembly has been designed such that the second gas 90 will not be vented out of the second cushion 34 during a crash. Of course, those of skill in the art will recognize that other embodiments may also be made such that the second gas 90 will be vented out of the second cushion 34 during a crash or accident.

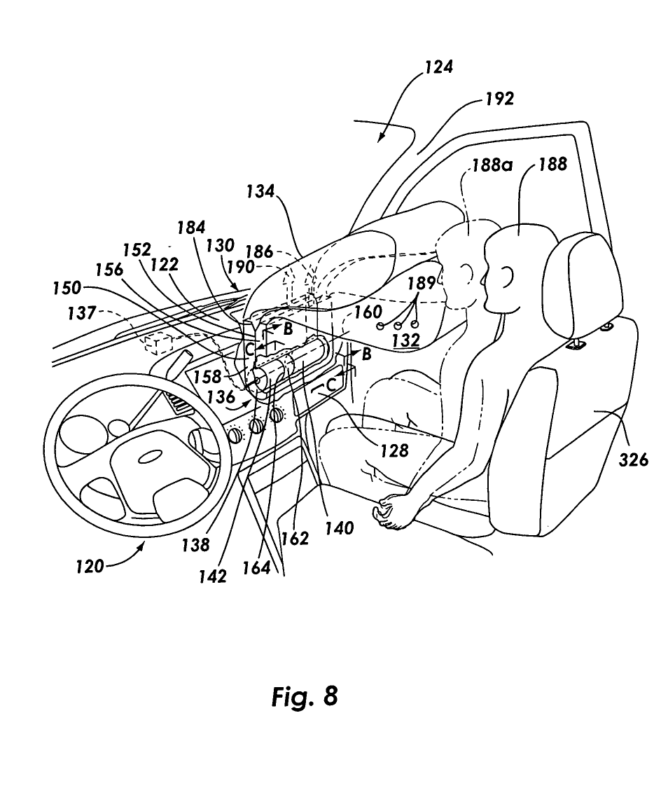

Referring now to FIG. 8, a further embodiment of the present invention is illustrated. More specifically, FIG. 8 is a partially cutaway perspective view of an airbag assembly 130 that has been added to a vehicle interior 120. As can be seen in FIG. 8, most of the components and elements of the airbag assembly 130 and the vehicle interior 120 are similar and/or equivalent to the components and elements that are found the embodiment described above.

The vehicle interior 120 includes that includes a dashboard 122, a windshield 124, a passenger seat 126 and a glove box 128. A vehicle occupant is also illustrated. The occupant may either be the properly positioned occupant 188 or an OOP occupant 188a (shown in phantom lines).

The airbag assembly 130 includes a first cushion 132 and a second cushion 134. The cushions 132, 134 are illustrated in their inflated and deployed configurations. As with the previous embodiments, the first cushion 132 is preferably shaped to mesh with the second cushion 134.

The airbag assembly 130 further comprises an inflator mechanism 136 that may independently inflate and deploy the cushions 132, 134 during a crash. The inflator mechanism 136 is a pyrotechnic or other device that is constructed such that it will begin to inflate the first cushion 132 prior to beginning the inflation of the second cushion 134. Additionally, an ECU 137 that detects a crash and/or provides an initiation signal to the inflator mechanism 136 has also been illustrated.

As with the previous embodiment, the inflator mechanism 136 may be a dual stage inflator 138 that comprises a first gas generating chamber 140 and a second gas generating chamber 142. Preferably, the first gas generating chamber 140 produces a first quantity of inflation gas that operates to inflate the first cushion 132 whereas the second gas generating chamber 142 produces a second quantity of inflation gas that is used to inflate the second cushion 134.

Referring still to FIG. 8, the airbag assembly 130 includes a housing 150 that is attached to the cushions 132, 134. The housing 150 is designed to enclose the inflator mechanism 136. A divider plate 152 that separates the housing 150 into a first chamber 156 and a second chamber 158 may additionally be added. However, unlike the embodiment shown above, the divider plate 152 is not positioned perpendicular to the longitudinal axis 160 of the inflator 138. On the contrary, in the embodiment shown in FIG. 8, the divider plate 152 extends parallel to the longitudinal axis 160. A V-shaped section 184 may also be added to the top of the divider plate 152.

The divider plate 152 may further be constructed such that it comprises a first annulus 162 and a second annulus 164. The annuluses 162, 164 comprise semi-circular extensions that protrude from opposite sides of the divider plate 152. Preferably, the annuluses 162, 164 are positioned such that when the inflator 138 is positioned within the housing 150, the first annulus 162 is positioned on the first gas generating chamber 140 and the second annulus 164 is positioned on the second gas generating chamber 142.

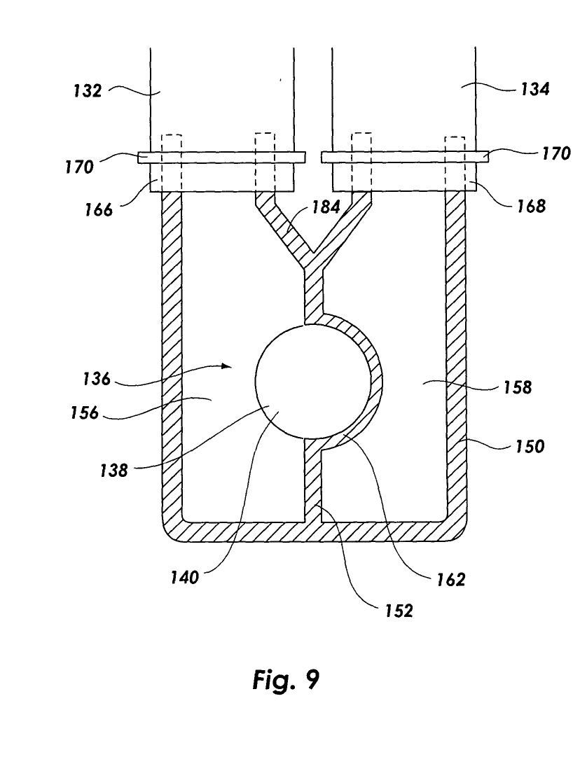

Referring now to FIG. 9, a cross-sectional view taken along the line B-B of FIG. 8 illustrates the housing 150, the inflator mechanism 136, and the airbag assembly 130 in greater detail. As can be seen in FIG. 9, the first chamber 156 is attached to a first throat portion 166 of the first cushion 132 whereas the second chamber 158 is attached to a second throat portion 168. As with the previous embodiment, this attachment may be accomplished via one or more clamp rings 170 that operate to cinch the throat portions 166, 168 over the chambers 156, 158.

Referring still to FIG. 9, the first annulus 162 is configured such that is covers a portion of the inflator 138. More specifically, the first annulus 162 is configured such that is covers a portion of the inflator 138 that is proximate to the second chamber 158, thereby ensuring that the inflation gas produced by the first gas generating chamber 140 will not flow and/or gain access into the second chamber 158.

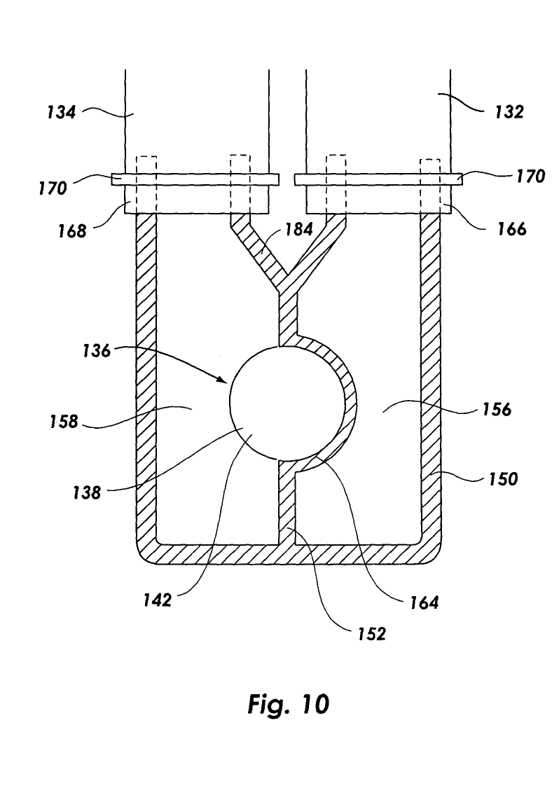

Referring now to FIG. 10, a cross-sectional view taken along the line C-C of FIG. 8 depicts the second annulus 164 covering a portion of the inflator 138. More specifically, the second annulus 164 covers a portion of the inflator 138 that is proximate the first chamber 156, thereby ensuring that the inflation gas produced by the second gas generating chamber 142 will not flow and/or gain access into the first chamber 156.

Referring now to FIGS. 8 through 10 generally, the inflation and deployment of the airbag assembly 130 will be described in greater detail. When the ECU 137 detects a crash, the ECU 137 signals the inflator mechanism 136 to begin deploying the first cushion 132. More specifically, the ECU 137 signals the inflator mechanism 136 to begin deploying the first cushion 132 by having the first gas generating chamber 140 produce a volume of first inflation gas 186 (represented graphically by an arrow).

After the first inflation gas 186 is produced, the gas 186 is directed out of the first gas generating chamber 140 into the first chamber 156. Because the first annulus 162 covers the portion of the inflator 138 that is proximate to the second chamber 158, the first inflation gas 186 produced by the first gas generating chamber 140 does not flow and/or gain access into the second chamber 158. Rather, the first gas 186 is directed into the first cushion 132 by flowing through the throat portion 166. In turn, this influx of the first gas 186 into the first cushion 132 causes the cushion 132 to inflate and deploy in a substantially vertical direction.

As with the previous embodiment, the first cushion 132 is constructed such that when it is inflated, the first cushion 132 may hold between about 60 to about 75 liters of the first inflation gas 186. Of course, other sizes of the first cushion 132 may also be used. In one of the presently preferred embodiments, the initial pressure of the inflation gas 186 within the first cushion 132 is less than about 2 psi, thereby ensuring that any contact between the first cushion 132 and the OOP occupant 188a will not injure the OOP occupant 188a. Of course, other embodiments may also be made in which the initial pressure of the inflation gas 186 within the first cushion 132 is greater than or equal to 2 psi.

The airbag assembly 130 may be further constructed such that if the inflated first cushion 132 contacts and/or impacts the OOP occupant 188a, the first cushion 132 will gently push the OOP occupant 188a towards the passenger seat 126. More specifically, if the inflated first cushion 132 impacts the OOP occupant 188a, the first cushion 132 will begin to gently push the OOP occupant 188a towards the passenger seat 126 such that the OOP occupant 188a begins to move away from the dashboard 124 prior to the deployment of the second cushion 134.

Additionally, the airbag assembly 130 may further be designed such that the first inflation gas 186 may be vented out of the first cushion 132 during a crash. As with the previous embodiment, such venting of the first gas 186 may be accomplished by adding one or more vent holes 189 to the first cushion 132.

As with the embodiment described above, the airbag assembly 130 may be configured such that a portion or section of the first cushion 132 is connected to a portion of the second cushion 134. As a result, when the first cushion 132 is inflated, the first cushion 132 pulls and/or exerts tension upon the uninflated second cushion 134 such that the uninflated second cushion 134 becomes positioned between the first cushion 132 and the windshield 124.

Once the ECU 137 has begun inflating the first cushion 132, the ECU 137 will cause the inflator mechanism 136 to begin inflating the second cushion 134. In some embodiments, the inflation of the second cushion 134 will not begin until after the first cushion 132 has been completely inflated and deployed. Other embodiments may also be constructed in which the second cushion 134 begins to inflate prior to the first cushion 132 being completely inflated and deployed by the first gas 186.

To deploy the second cushion 134, the ECU 137 causes the second gas generating chamber 142 to produce a volume of second inflation gas 190 (represented graphically by an arrow). This second inflation gas 190 is directed out of the second gas generating chamber 142 and enters the second chamber 158. Because the second annulus 164 covers the portion of the inflator 138 that is proximate to the first chamber 156, the second inflation gas 190 produced by the second gas generating chamber 142 does not flow and/or gain access into the first chamber 156. Rather, the second inflation gas 190 is directed into the second cushion 134 by flowing through the throat portion 168. In turn, this influx of the second gas 190 into the second cushion 134 causes the cushion 134 to inflate and deploy upwardly towards the windshield 124.

Preferably, the second cushion 134 is constructed such that the pressure of the second inflation gas 190 within the second cushion 134 is greater than the pressure of the first gas 186 within the first cushion 132. Additionally, the embodiment shown in FIGS. 8 through 10 is constructed such that when the second cushion 134 is inflated, the second cushion 134 becomes positioned behind the first cushion 132. More specifically, the second cushion 134 is constructed such that when it is inflated, the second cushion 134 becomes positioned between the windshield 124 and the first cushion 132. In some embodiments, such positioning of the second cushion 134 may be preferable in that it will push the first cushion 132 away from the windshield 124. This movement of the first cushion 132 ensures that the first cushion 132 becomes situated in a position that is capable of restraining the movement of the vehicle occupant 188, 188a during a crash.

The airbag assembly 130 has further been constructed such that the second cushion 134 will not impact the occupant 188a until after the second cushion 134 has moved the first cushion 132 into a position that is capable of restraining the movement of the occupant 188, 188a. Of course, other embodiments may also be made such that the second cushion 134 will not impact either the vehicle occupant 188 or the OOP occupant 188a until after the second cushion 134 has been fully inflated and deployed. Yet further embodiments may also be made in which the airbag assembly 130 is constructed such that the second cushion 134 will impact a portion of the vehicle occupant 188, 188a during deployment. Still further embodiments may be constructed such that after the second cushion 134 has been deployed, the second cushion 134 will receive and/or cushion the head or torso of the vehicle occupant 188, 188a.

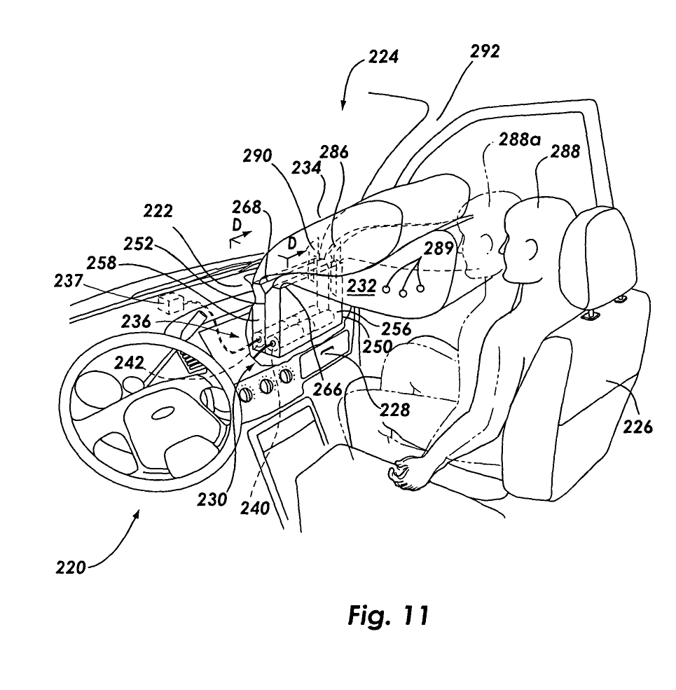

Referring now to FIG. 11, a further embodiment of the present invention is illustrated. More specifically, FIG. 11 is a partially cutaway perspective view of an airbag assembly 230 that has been added to a vehicle interior 220. As can be seen in FIG. 11, most of the components and elements of the airbag assembly 230 and the vehicle interior 220 are similar and/or equivalent to the components and elements that are found the embodiments described above.

The vehicle interior 220 includes a dashboard 222, a windshield 224, a passenger seat 226 and a glove box 228. A vehicle occupant is also illustrated. The occupant may either be the properly positioned occupant 288 or an OOP occupant 288a (shown in phantom lines).

The airbag assembly 230 includes a first cushion 232 and a second cushion 234. The cushions 232, 234 are illustrated in their inflated and deployed configurations. As with the previous embodiments, the first 232 is preferably shaped to mesh with the second cushion 234.

The airbag assembly 230 further comprises an inflator mechanism 236 that may independently inflate and deploy the cushions 232, 234 during a crash. The inflator mechanism 236 is a device that is constructed such that it will begin to inflate the first cushion 232 prior to beginning the inflation of the second cushion 234. Additionally, an ECU 237 that detects a crash and/or provides an initiation signal to the inflator mechanism 236 has also been illustrated.

However, unlike the embodiments described above, the inflator mechanism 236 does not comprise a dual stage inflator. Rather in this embodiment, the inflator mechanism 236 comprises two distinct inflators. More specifically, the inflator mechanism 236 comprises a first inflator 240 and a second inflator 242 that is separate and distinct from the first inflator 240. The inflators 240, 242 may be selected from any of the types of inflating devices known in the art including pyrotechnic, gas generating, stored gas, or “hybrid” type inflators. Preferably, the inflators 240, 242 are constructed and designed such that in the event of an accident or crash, the first inflator 240 will inflate the first cushion 232 and the second inflator 242 will inflate the second cushion 234.

Referring still to FIG. 11, the airbag assembly 230 also includes a housing 250 that is attached to the cushions 232, 234. The housing 250 is designed to enclose the inflator mechanism 236. More particularly, the housing 250 is designed such that it may enclose the first inflator 240 and the second inflator 242.

A divider plate 252 that separates the housing 250 into a first chamber 256 and a second chamber 258 may additionally be added. Preferably, the divider plate 252 provides an airtight seal between the first chamber 256 and the second chamber 258. The first inflator 240 is housed with the first chamber 256 and the second inflator 242 is housed within the second chamber 258. A V-shaped section 284 may also be added to the top of the divider plate 252.

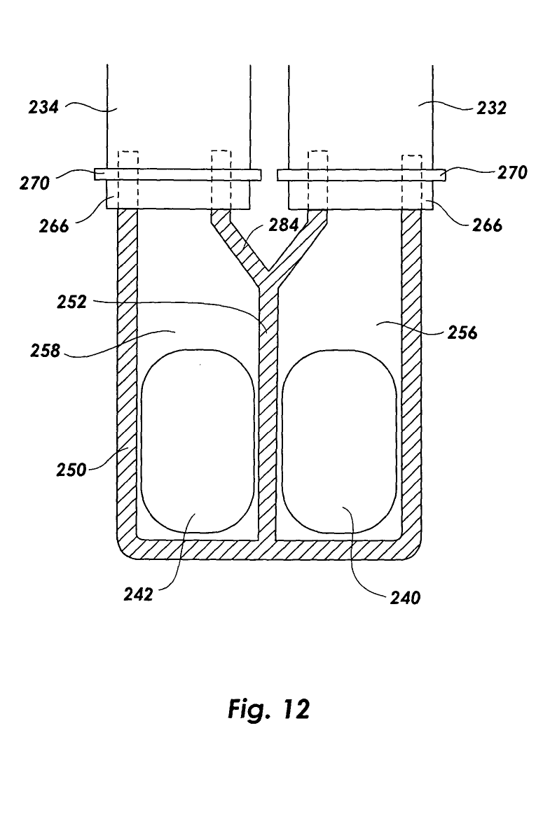

Referring now to FIG. 12, a cross-sectional view taken along the line D-D of FIG. 8 illustrates the housing 250, the inflator mechanism 236, and the airbag assembly 230 in greater detail. As can be seen in FIG. 12, the first chamber 256 is attached to a first throat portion 266 of the first cushion 232. Similarly, the second chamber 258 is attached to a second throat portion 268 of the second cushion 234. As with the previous embodiment, this attachment between the chambers 256, 258 and the throat portions 266, 268 may be accomplished via one or more clamp rings 270 that operate to cinch the throat portions 266, 268 over the chambers 256, 258.

Referring now to FIGS. 11 and 12 generally, the inflation and deployment of the airbag assembly 230 will be described in greater detail. As with the embodiments described above, when the ECU 237 detects a crash, the ECU 237 signals the inflator mechanism 236 to begin deploying the first cushion 232. More specifically, the ECU 237 signals the inflator mechanism 236 to begin deploying the first cushion 232 by having the first inflator 240 produce a volume of first inflation gas 286 (represented graphically by an arrow).

After the first inflation gas 286 is produced, the gas 286 is directed out of the first inflator 240 into the first chamber 256. Because the first chamber 256 is sealed off from the second chamber 256, the first inflation gas 286 does not flow and/or gain access into the second chamber 258. Rather, the first gas 286 is directed into the first cushion 232 by flowing through the throat portion 266. In turn, this influx of the first gas 186 into the first cushion 232 causes the cushion 232 to inflate and deploy in a substantially vertical direction.

As with the previous embodiment, the first cushion 232 is constructed such that when it is inflated, the first cushion 232 may hold between about 60 to about 75 liters of the first inflation gas 286. Of course, other sizes of the first cushion 232 may also be used. In one of the presently preferred embodiments, the initial pressure of the inflation gas 286 within the first cushion 232 is less than about 2 psi, thereby ensuring that any contact between the first cushion 232 and the OOP occupant 288a will not injure the OOP occupant 288a. Of course, other embodiments may also be made in which the initial pressure of the inflation gas 286 within the first cushion 232 is greater than or equal to 2 psi.

The airbag assembly 230 may be further constructed such that if the inflated first cushion 232 contacts and/or impacts the OOP occupant 288a, the first cushion 232 will gently push the OOP occupant 288a towards the passenger seat 226. More specifically, if the inflated first cushion 232 impacts the OOP occupant 288a, the first cushion 232 will begin to gently push the OOP occupant 288a towards the passenger seat 226 such that the OOP occupant 288a begins to move away from the dashboard 224 prior to the deployment of the second cushion 234.

Additionally, the airbag assembly 230 may further be designed such that the first inflation gas 286 may be vented out of the first cushion 232 during a crash. Such venting of the first gas 286 may be accomplished by adding one or more vent holes 289 to the first cushion 232. Other methods for venting the first gas 286 may also be used.

As with the embodiments described above, the airbag assembly 230 may be configured such that a portion or section of the first cushion 232 is connected to a portion of the second cushion 234. As a result, when the first cushion 232 is inflated, the first cushion 234 pulls and/or exerts tension upon the uninflated second cushion 234 such that the uninflated second cushion 234 becomes positioned between the first cushion 232 and the windshield 224.

Once the ECU 237 has begun inflating the first cushion 232, the ECU 237 will cause the inflator mechanism 236 to begin inflating the second cushion 234. In some embodiments, the inflation of the second cushion 234 will not begin until after the first cushion 232 has been completely inflated and deployed. However, other embodiments may also be constructed in which the second cushion 234 begins to inflate prior to the first cushion 232 being completely inflated and deployed by the first gas 286.

To deploy the second cushion 234, the ECU 237 causes the second inflator 242 to produce a volume of second inflation gas 290 (represented graphically by an arrow). This second inflation gas 290 is directed out of the second inflator 242 and enters the second chamber 258. As this second chamber 256 is sealed, the second gas 290 cannot flow and/or gain access into the first chamber 256. Rather, the second inflation gas 290 is directed into the second cushion 234 by flowing through the second throat portion 268. In turn, this influx of the second gas 290 into the second cushion 234 causes the cushion 234 to inflate and deploy upwardly towards the windshield 224.

Preferably, the second cushion 234 is constructed such that the pressure of the second inflation gas 290 within the second cushion 234 is greater than the pressure of the first gas 286 within the first cushion 232. Additionally, the embodiment shown in FIGS. 11 and 12 is constructed such that when the second cushion 234 is inflated, the second cushion 234 becomes positioned behind the first cushion 232. More specifically, the second cushion 234 is constructed such that when it is inflated, the second cushion 234 becomes positioned between the windshield 224 and the first cushion 232. In some embodiments, such positioning of the second cushion 234 may be preferable in that it will push the first cushion 232 away from the windshield 224. This movement of the first cushion 232 ensures that the first cushion 232 becomes situated in a position that is capable of restraining the movement of the vehicle occupant 288, 288a during a crash.

The airbag assembly 230 has further been constructed such that the second cushion 234 will not impact the occupant 288a until after the second cushion 234 has moved the first cushion 232 into a position that is capable of restraining the movement of the occupant 288, 288a. Of course, other embodiments may also be made such that the second cushion 234 will not impact either the vehicle occupant 288 or the OOP occupant 288a until after the second cushion 234 has been fully inflated and deployed. Yet further embodiments may also be made in which the airbag assembly 230 is constructed such that the second cushion 234 will impact a portion of the vehicle occupant 288, 288a during deployment. Still further embodiments may be constructed such that after the second cushion 234 has been deployed, the second cushion 234 will receive and/or cushion the head or torso of the vehicle occupant 288, 288a.

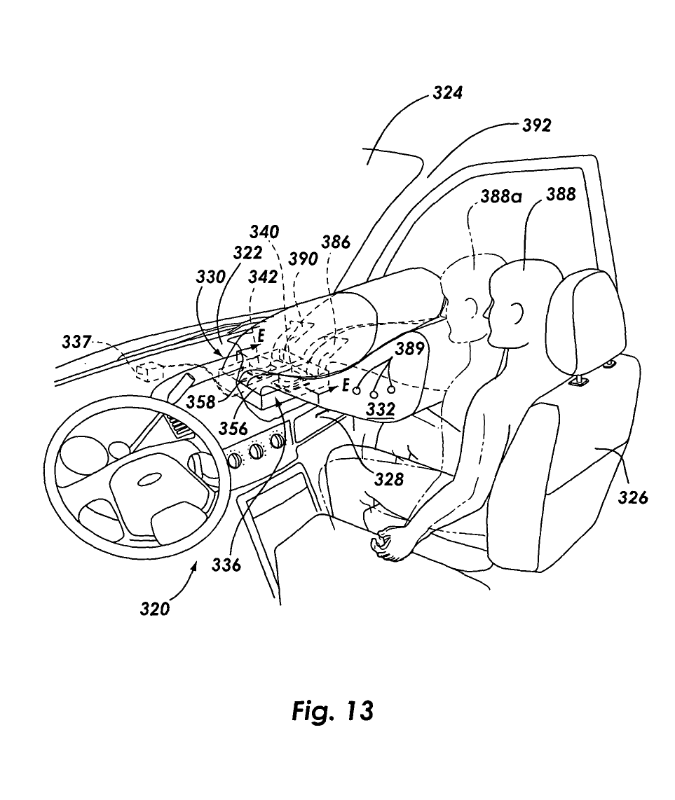

Referring now to FIG. 13, a further embodiment of the present invention is illustrated. More specifically, FIG. 13 is a partially cutaway perspective view of an airbag assembly 330 that has been added to a vehicle interior 320. As can be seen in FIG. 13, most of the components and elements of the airbag assembly 330 and the vehicle interior 320 are similar and/or equivalent to the components and elements that are found the embodiments described above.

The vehicle interior 320 includes a dashboard 322, a windshield 324, a passenger seat 326 and a glove box 328. A vehicle occupant is also illustrated. The occupant may either be the properly positioned occupant 388 or an OOP occupant 388a (shown in phantom lines).

The airbag assembly 330 includes a first cushion 332 and a second cushion 334. The cushions 332, 334 are illustrated in their inflated and deployed configurations. As with the previous embodiments, the first cushion 332 is preferably shaped to mesh with the second cushion 334.

The airbag assembly 330 further comprises an inflator mechanism 336 that may independently inflate and deploy the cushions 332, 334 during a crash. The inflator mechanism 336 is a device that is constructed such that it will begin to inflate the first cushion 332 prior to beginning the inflation of the second cushion 334. Additionally, an ECU 337 that detects a crash and/or provides an initiation signal to the inflator mechanism 336 has also been shown.

As with the embodiment shown in FIGS. 11 and 12, the embodiment shown in FIG. 13 is constructed such that the inflator mechanism 338 comprises two distinct inflators: a first inflator 340 and a second inflator 342. The inflators 340, 342 may be selected from any of the types of inflating devices known in the art. Preferably, the inflators 340, 342 are constructed and designed such that in the event of an accident or crash, the first inflator 340 will inflate the first cushion 332 and the second inflator 342 will inflate the second cushion 334.

Referring still to FIG. 13, the airbag assembly 330 also includes a housing 350 that is attached to the cushions 332, 334. The housing 350 is designed to enclose the inflator mechanism 336. More particularly, the housing 350 is designed such that it may enclose the first inflator 340 and the second inflator 342.

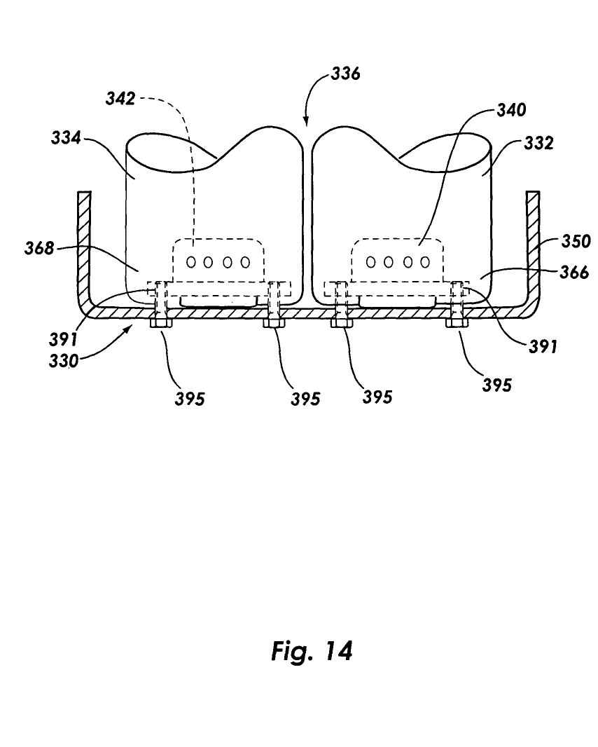

Referring now to FIG. 14, a cross-sectional view taken along the line E-E of FIG. 13 illustrates the housing 350, the inflator mechanism 336, and the airbag assembly 330 in greater detail. As can be seen in FIG. 14, the embodiment shown in FIG. 14 differs from the embodiments described above in that the housing 350 does not contain a divider plate that operates to separate the first inflator 340 from the second inflator 342. Rather, when the inflators 340, 342 are positioned within the housing 350, the first inflator 340 is positioned adjacent to the second inflator 342.

The embodiment shown in FIG. 14 further differs from the embodiments described above in that a portion of the first inflator 340 is installed within the first cushion 32 and a portion of the second inflator 342 is installed within the second cushion 334. More specifically, a portion of the first inflator 340 is installed within a first throat portion 366 of the first cushion 332 and a portion of the second inflator 342 is installed within a second throat portion 368 of the second cushion 334. In FIG. 14, such installation of the inflators 340, 342 is accomplished by surrounding the inflators 340, 342 with a nut 391 and then attaching the nut 391 to the throat portions 366, 368 via one or more bolts 395. Of course, those of skill in the art will recognize that other ways and/or methods of installing the inflators 340, 342 within the throat portions 366, 368 may also be used.

Referring now to FIGS. 13 and 14 generally, the inflation and deployment of the airbag assembly 330 will be described in greater detail. As with the embodiments described above, when the ECU 337 detects a crash, the ECU 337 signals the inflator mechanism 336 to begin deploying the first cushion 332. More specifically, the ECU 337 signals the inflator mechanism 336 to begin deploying the first cushion 332 by having the first inflator 340 produce a volume of first inflation gas 386 (represented graphically by an arrow).

After the first inflation gas 386 is produced, the gas 386 is directed out of the first inflator 240 into the throat portion 366 of the first cushion 332. In turn, this influx of the first gas 386 causes the cushion 332 to inflate and deploy in a substantially vertical direction.

As with the previous embodiment, the first cushion 332 is constructed such that when it is inflated, the first cushion 332 may hold between about 60 to about 75 liters of the first inflation gas 386. Of course, other sizes of the first cushion 332 may also be used. In one of the presently preferred embodiments, the initial pressure of the inflation gas 386 within the first cushion 332 is less than about 2 psi, thereby ensuring that any contact between the first cushion 332 and the OOP occupant 388a will not injure the OOP occupant 388a. Of course, other embodiments may also be made in which the initial pressure of the inflation gas 386 within the first cushion 332 is greater than or equal to 2 psi.

The airbag assembly 330 may be further constructed such that if the inflated first cushion 332 contacts and/or impacts the OOP occupant 388a, the first cushion 332 will gently push the OOP occupant 388a towards the passenger seat 326. More specifically, if the inflated first cushion 332 impacts the OOP occupant 388a, the first cushion 332 will begin to gently push the OOP occupant 388a towards the passenger seat 326 such that the OOP occupant 388a begins to move away from the dashboard 324 prior to the deployment of the second cushion 334.

Additionally, the airbag assembly 330 may further be designed such that the first inflation gas 386 may be vented out of the first cushion 332 during a crash. Such venting of the first gas 386 may be accomplished by adding one or more vent holes 389 to the first cushion 332. Other methods for venting the first gas 386 may also be used.

As with the embodiments described above, the airbag assembly 330 may be configured such that a portion or section of the first cushion 332 is connected to a portion of the second cushion 334. As a result, when the first cushion 332 is inflated, the first cushion 332 pulls and/or exerts tension upon the uninflated second cushion 334 such that the uninflated second cushion 334 becomes positioned between the first cushion 332 and the windshield 324.

Once the ECU 337 has begun inflating the first cushion 332, the ECU 337 will cause the inflator mechanism 336 to begin inflating the second cushion 334. In some embodiments, the inflation of the second cushion 334 will not begin until after the first cushion 332 has been completely inflated and deployed. However, other embodiments may also be constructed in which the second cushion 334 begins to inflate prior to the first cushion 232 being completely inflated and deployed by the first gas 386.

To deploy the second cushion 334, the ECU 337 causes the second inflator 342 to produce a volume of second inflation gas 390 (represented graphically by an arrow). This second inflation gas 390 is directed out of the second inflator 342 and enters the second cushion 334 via the second throat portion 368. In turn, this influx of the second gas 390 causes the cushion 334 to inflate and deploy upwardly towards the windshield 324.

Preferably, the second cushion 334 is constructed such that the pressure of the second inflation gas 390 within the second cushion 334 is greater than the pressure of the first gas 386 within the first cushion 332. Additionally, the embodiment shown in FIGS. 13 and 14 is constructed such that when the second cushion 334 is inflated, the second cushion 334 becomes positioned behind the first cushion 332. More specifically, the second cushion 334 is constructed such that when it is inflated, the second cushion 334 becomes positioned between the windshield 324 and the first cushion 332. In some embodiments, such positioning of the second cushion 334 may be preferable in that it will push the first cushion 332 away from the windshield 324. This movement of the first cushion 332 ensures that the first cushion 332 becomes situated in a position that is capable of restraining the movement of the vehicle occupant 388, 388a during a crash.

The airbag assembly 330 has further been constructed such that the second cushion 234 will not impact the occupant 388a until after the second cushion 334 has moved the first cushion 332 into a position that is capable of restraining the movement of the occupant 388, 388a. Of course, other embodiments may also be made such that the second cushion 334 will not impact either the vehicle occupant 388 or the OOP occupant 388a until after the second cushion 334 has been fully inflated and deployed. Yet further embodiments may also be made in which the airbag assembly 330 is constructed such that the second cushion 334 will impact a portion of the vehicle occupant 388, 388a during deployment. Still further embodiments may be constructed such that after the second cushion 334 has been deployed, the second cushion 334 will receive and/or cushion the head or torso of the vehicle occupant 388, 388a.

In summary, the present invention provides novel passenger airbag assemblies that comprise two distinct cushions and are designed such that they will not cause injury to the vehicle passengers. As such, many of the limitations associated with known passenger airbag assemblies have been effectively eliminated.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A passenger airbag assembly comprising:
a first cushion;
a second cushion;
a housing that is attached to the first cushion and the second cushion, and
an inflator mechanism that independently inflates the first cushion and the second cushion, the inflator mechanism being constructed to begin the inflation of the first cushion prior to beginning the inflation of the second cushion.

2. A passenger airbag assembly as in claim 1 wherein the inflator mechanism comprises a dual stage inflator.

3. A passenger airbag assembly as in claim 1 wherein the inflator mechanism comprises a first inflator that inflates the first cushion and a second inflator that inflates the second cushion.

4. A passenger airbag assembly as in claim 1 wherein the second cushion is separate from the first cushion.

5. A passenger airbag assembly as in claim 1 wherein the housing further comprises a divider plate that separates the first cushion from the second cushion.

6. A passenger airbag assembly as in claim 1 wherein the pressure of the second cushion is higher than the pressure of the first cushion.

7. A passenger airbag assembly as in claim 1 wherein the volume of the first cushion is between about 60 and about 75 liters.

8. A passenger airbag assembly as in claim 1 wherein the second cushion is designed such that when it is inflated, the second cushion is positioned behind the first cushion.

9. A passenger airbag assembly as in claim 1 wherein the second cushion is designed such that when it is inflated, the second cushion is positioned between the windshield and the first cushion.

10. A passenger airbag assembly as in claim 1 wherein the second cushion is constructed such that when the second cushion is inflated, the pressure of the second cushion is between about 4 to about 7 pounds per square inch.

11. A passenger airbag assembly as in claim 1 wherein the airbag assembly is constructed such that inflation gas may be vented out of the first cushion during a crash.

12. A passenger airbag assembly as in claim 1 wherein the second cushion is not vented during a crash.

13. A passenger airbag assembly as in claim 1 wherein the second cushion is vented during a crash.

14. A passenger airbag assembly as in claim 1 wherein the airbag assembly is further constructed such that when the first cushion is inflated, the first cushion pulls upon the second cushion.

15. A passenger airbag assembly as in claim 1 wherein the airbag assembly is further constructed such that as the first cushion is being inflated, the first cushion will pull upon the uninflated second cushion such that all or a portion of the uninflated second cushion becomes positioned between the first cushion and the vehicle's windshield.

16. A passenger airbag assembly as in claim 1 wherein the first cushion is connected to the second cushion.

17. A passenger airbag assembly as in claim 17 wherein a top portion of the first cushion is connected to a top portion of the second cushion.

18. A passenger airbag assembly as in claim 1 wherein the initial pressure of the inflation gas within the first cushion is less than about 2 pounds per square inch.

19. A passenger airbag assembly as in claim 1 wherien the first cushion deploys in a substantially vertical direction.

20. A passenger airbag assembly as in claim 1 wherein when the first cushion and the second cushion are inflated, the second cushion pushes the first cushion away from the vehicle's windshield.

21. A passenger airbag assembly as in claim 1 wherein the airbag assembly is constructed such that when the first and second cushions are inflated, the second cushion will push the first cushion away from the vehicle's windshield and into a position that is capable of restraining the movement of a vehicle occupant.

22. A passenger airbag assembly as in claim 1 wherein airbag assembly is constructed such that when the first cushion is inflated, the first cushion pushes an out of position vehicle occupant towards the vehicle's passenger seat.

23. A passenger airbag assembly as in claim 22 wherein the airbag assembly is constructed such that when the first cushion is inflated, the first cushion will push an out of position vehicle occupant towards the passenger seat such that the out of position occupant will begin to move away from the vehicle's dashboard.

24. A passenger airbag assembly as in claim 1 wherein the second cushion is constructed such that when the second cushion is inflated, the second cushion will cover the A-pillar of the vehicle.

25. A passenger airbag assembly as in claim 1 wherein the first cushion is shaped to mesh with the second cushion.

26. A passenger airbag assembly as in claim 1 wherein the first cushion defines a jog that accommodates the deployment of the second cushion.

27. A passenger airbag assembly as in claim 1 wherein the shape of the second cushion is designed to follow the contours of the vehicle interior.

28. A passenger airbag assembly as in claim 1 wherein the airbag assembly is constructed such that the second cushion will not impact a vehicle occupant until after the second cushion has been fully inflated and deployed.

29. A passenger airbag assembly as in claim 1 wherein the airbag assembly is constructed such that the second cushion will not impact an out of position vehicle occupant until after the second cushion has moved the first cushion into a position that is capable of restraining the movement of the out of position occupant.

30. A passenger airbag assembly comprising:
a first cushion;
a second cushion;
a housing that is attached to the first cushion and the second cushion, the housing including a divider plate; and
an inflator mechanism that independently inflates the first cushion and the second cushion, the inflator mechanism being constructed to begin the inflation of the first cushion prior to beginning the inflation of the second cushion.

31. A passenger airbag assembly as in claim 30 wherein the inflator mechanism comprises a dual stage inflator.

32. A passenger airbag assembly as in claim 30 wherein the inflator mechanism comprises a first inflator that inflates the first cushion and a second inflator that inflates the second cushion.

33. A passenger airbag assembly as in claim 30 wherein the divider plate comprises a first annulus and a second annulus.

34. A passenger airbag assembly as in claim 30 wherein the pressure of the second cushion is higher than the pressure of the first cushion.

35. A passenger airbag assembly as in claim 30 wherein the second cushion is designed such that when it is inflated, the second cushion fits between the windshield and the first cushion.

36. A passenger airbag assembly as in claim 30 wherein the airbag assembly is further constructed such that as the first cushion is being inflated, the first cushion will pull upon the uninflated second cushion such that all or a portion of the uninflated second cushion becomes positioned between the first cushion and the vehicle's windshield.

37. A passenger airbag assembly as in claim 30 wherein the airbag assembly is constructed such that the second cushion will not impact a vehicle occupant until after the second cushion has been fully inflated and deployed.

38. A passenger airbag assembly as in claim 30 wherein when the first cushion and the second cushion are inflated, the second cushion pushes the first cushion away from the vehicle's windshield and into a position that is capable of restraining the movement of a vehicle occupant during a crash.

39. A passenger airbag assembly as in claim 30 wherein airbag assembly is constructed such that when the first cushion is inflated, the first cushion pushes an out of position vehicle occupant towards the vehicle's passenger seat.

40. A passenger airbag assembly as in claim 39 wherein the airbag assembly is constructed such that when the first cushion is inflated, the first cushion will push an out of position vehicle occupant towards the passenger seat such that the out of position occupant will begin to move away from the dashboard.

41. A passenger airbag assembly as in claim 30 wherein the first cushion is shaped to mesh with the second cushion.

42. A passenger airbag assembly as in claim 30 wherein the first cushion defines a jog that accommodates the deployment of the second cushion.

43. A passenger airbag assembly as in claim 30 wherein the airbag assembly is constructed such that when the first and second cushions are inflated, the second cushion will push the first cushion away from the vehicle's windshield and into a position that is capable of restraining the movement of a vehicle occupant.

44. A passenger airbag assembly as in claim 30 wherein the airbag assembly is constructed such that the second cushion will not impact an out of position vehicle occupant until after the second cushion has moved the first cushion into a position that is capable of restraining the movement of the out of position occupant.

45. A passenger airbag assembly comprising:
a first cushion;
a second cushion;
a housing that is attached to the first cushion and the second cushion, and
an inflator mechanism that independently inflates the first cushion and the second cushion, the airbag assembly being constructed such that when the first cushion is inflated, the second cushion will push the first cushion away from the vehicle's windshield and into a position that is capable of restraining the movement of a vehicle occupant.

46. A passenger airbag assembly as in claim 45 wherein the inflator mechanism is constructed to begin the inflation of the first cushion prior to beginning the inflation of the second cushion.

47. A passenger airbag assembly as in claim 45 wherein the inflator mechanism comprises a dual stage inflator.

48. A passenger airbag assembly as in claim 45 wherein the inflator mechanism comprises a first inflator that inflates the first cushion and a second inflator that inflates the second cushion.

49. A passenger airbag assembly as in claim 45 further comprising a divider plate separates the first cushion from the second cushion.

50. A passenger airbag assembly as in claim 45 wherein the pressure of the second cushion is higher than the pressure of the first cushion.

51. A passenger airbag assembly as in claim 45 wherein the second cushion is designed such that when it is inflated, the second cushion is positioned between the windshield and the first cushion.

52. A passenger airbag assembly as in claim 45 wherein the airbag assembly is further constructed such that as the first cushion is being inflated, the first cushion will pull upon the uninflated second cushion such that all or a portion of the uninflated second cushion becomes positioned between the first cushion and the vehicle's windshield.

53. A passenger airbag assembly as in claim 45 wherein when the first cushion and the second cushion are inflated, the second cushion pushes the first cushion away from the vehicle's windshield.

54. A passenger airbag assembly as in claim 45 wherein the first cushion is shaped to mesh with the second cushion.

55. A passenger airbag assembly as in claim 45 wherein the first cushion defines a jog that accommodates the deployment of the second cushion.

56. A passenger airbag assembly as in claim 45 wherein the airbag assembly is constructed such that the second cushion will not impact a vehicle occupant until after the second cushion has been fully inflated and deployed.

57. A passenger airbag assembly as in claim 45 wherein the airbag assembly is constructed such that when the first and second cushions are inflated, the second cushion will push the first cushion away from the vehicle's windshield and into a position that is capable of restraining the movement of a vehicle occupant.

58. A passenger airbag assembly as in claim 45 wherein the airbag assembly is constructed such that the second cushion will not impact an out of position vehicle occupant until after the second cushion has moved the first cushion into a position that is capable of restraining the movement of the out of position occupant.

59. A passenger airbag assembly comprising:
a first cushion;
a second cushion;
a housing that is attached to the first cushion and the second cushion, and
an inflator mechanism that independently inflates the first cushion and the second cushion, the airbag assembly being constructed such that when the first cushion and the second cushion are inflated, the second cushion is positioned between the windshield and the first cushion.

60. A passenger airbag assembly as in claim 59 wherein the inflator mechanism is constructed to begin the inflation of the first cushion prior to beginning the inflation of the second cushion.

61. A passenger airbag assembly as in claim 59 further comprising a divider plate that separates the first cushion from the second cushion.

62. A passenger airbag assembly as in claim 59 wherein the pressure of the second cushion is higher than the pressure of the first cushion.

63. A passenger airbag assembly as in claim 59 wherein the airbag assembly is further constructed such that as the first cushion is being inflated, the first cushion will pull upon the uninflated second cushion such that all or a portion of the uninflated second cushion becomes positioned between the first cushion and the vehicle's windshield.

64. A passenger airbag assembly as in claim 59 wherein when the first cushion and the second cushion are inflated, the second cushion pushes the first cushion away from the vehicle's windshield.

65. A passenger airbag assembly as in claim 59 wherein airbag assembly is constructed such that when the first cushion is inflated, the first cushion will push an out of position vehicle occupant towards the passenger seat such that the out of position occupant will begin to move away from the vehicle's dashboard.

66. A passenger airbag assembly as in claim 59 wherein the first cushion is shaped to mesh with the second cushion.

67. A passenger airbag assembly as in claim 59 wherein the first cushion defines a jog that accommodates the deployment of the second cushion.

68. A passenger airbag assembly as in claim 59 wherein the airbag assembly is constructed such that the second cushion will not impact a vehicle occupant until after the second cushion has been fully inflated and deployed.

69. A passenger airbag assembly comprising:
a first cushion;
a second cushion;
a housing that is attached to the first cushion and the second cushion, and
an inflator mechanism that independently inflates the first cushion and the second cushion, the airbag assembly being constructed such that the second cushion will not impact a vehicle occupant until after the second cushion has been fully inflated and deployed.

70. A passenger airbag assembly as in claim 69 wherein the inflator mechanism is constructed to begin the inflation of the first cushion prior to beginning the inflation of the second cushion.

71. A passenger airbag assembly as in claim 69 further comprising a divider plate that separates the first cushion from the second cushion.

72. A passenger airbag assembly as in claim 69 wherein the pressure of the second cushion is higher than the pressure of the first cushion.

73. A passenger airbag assembly as in claim 69 wherein the airbag assembly is further constructed such that as the first cushion is being inflated, the first cushion will pull upon the uninflated second cushion such that all or a portion of the uninflated second cushion becomes positioned between the first cushion and the vehicle's windshield.

74. A passenger airbag assembly as in claim 69 wherein when the first cushion and the second cushion are inflated, the second cushion pushes the first cushion away from the vehicle's windshield.

75. A passenger airbag assembly as in claim 69 wherein airbag assembly is constructed such that when the first cushion is inflated, the first cushion will push an out of position vehicle occupant towards the passenger seat such that the out of position occupant will begin to move away from the vehicle's dashboard.

76. A passenger airbag assembly as in claim 69 wherein the first cushion is shaped to mesh with the second cushion.

77. A passenger airbag assembly as in claim 69 wherein the first cushion defines a jog that accommodates the deployment of the second cushion.

78. A passenger airbag assembly as in claim 69 wherein the airbag assembly is constructed such that when the first cushion and the second cushion are inflated, the second cushion is positioned between the windshield and the first cushion.

79. A method for restraining the movement of a vehicle occupant using an airbag assembly having a first cushion and a second cushion positioned within a vehicle dashboard, the method comprising:
inflating the first cushion is a substantially vertical direction; and
inflating the second cushion, wherein the inflation of the second pushes the first cushion away from the vehicle's windshield and into a position that is capable of restraining the movement of the vehicle occupant.

80. A method as in claim 79 wherein the second cushion inflates into a position that is between the first cushion and the windshield.

81. A method as in claim 79 wherein the second cushion is at a higher pressure than the first cushion.

82. A method as in claim 79 wherein the initial pressure of the first cushion is less than about 2 pounds per square inch.

83. A method as in claim 79 wherein the airbag assembly is constructed such that as the first cushion is being inflated, the first cushion will pull upon the uninflated second cushion such that all or a portion of the uninflated second cushion becomes positioned between the first cushion and the vehicle's windshield.

84. A method as in claim 79 wherein the inflation of the second pushes the first cushion towards the vehicle's passenger seat.

85. A method as in claim 79 wherein the airbag assembly is constructed such that when the first cushion is inflated, the first cushion will push an out of position vehicle occupant towards the passenger seat such that the out of position occupant will begin to move away from the vehicle's dashboard.
